(19) United States
(12) Patent Application Publication
(10) Pub. No.: US 2002/0193484 A1
(43) Pub. Date: Dec. 19, 2002

(54) Polymeric resins impregnated with insect repellants

(75) Inventor: Eric Albee, Shamong, NJ (US)

Correspondence Address: BRUCE E. LILLING, LILLING & LILLING P.C., P.O. BOX 560, GOLDEN BRIDGE, NY, 10526, US

(73) Assignee: The 54 Group, Ltd., Scarsdale, NY

(21) Appl. No.: 10/096,364

(22) Filed: Mar. 12, 2002

Related U.S. Application Data
(63) Continuation-in-part of application No. 10/058,573, filed on Jan. 28, 2002.
(60) Provisional application No. 60/266,486, filed on Feb. 2, 2001.

(51) Int. Cl. C08K 5/07

(52) U.S. Cl. 524/354; 524/476; 424/403

(57) ABSTRACT

The present invention relates to non-foamed insect repellent concentrates that include polymeric resins that have been impregnated with insect repellents and methods for making same. Additionally, the present invention relates to products formed from insect repellent impregnated polymeric resins and methods for making same. Preferred products such as, for example, plastic tablecloths, plastic garbage receptacles and plastic garbage lawn bags are described.

### FIELD OF THE INVENTION

The invention relates to non-foamed insect repellent concentrates containing polymeric resin and insect repellents, a process for impregnating polymeric resins with such repellents, the preparation of non-foamed insect repellent concentrates from such impregnated resins and articles made using such impregnated resins or concentrates.

### BACKGROUND OF THE INVENTION

For many years, it has been know how to impregnate plastics with various chemical compositions so that these compositions are slowly released from the plastic. Such impregnated plastics have been used inter alia to form antibiotic impregnated medical devices that prevent infection, dry-cleaning solvent impregnated devices for home dry cleaning and insecticide impregnated polymeric foams for use as building materials.

Rutherford (U.S. Pat. No. 4,542,162) discloses foamed thermoplastic particles impregnated with insect repellents. A blowing agent is used to prevent oiling out of the repellents. According to this process, a single screw or double screw extruder is used, and resin particles are added and melted upstream from the point of addition of the insect repellent fluid, which in turn is added upstream from the point of addition of the blowing agent.

In prior art, it has been noted that insect repellents oil out if a blowing agent is not added. However, blowing allows only for the formation of foamed plastics. Accordingly, there exists a need for polymeric resins that have been impregnated with insect repellents that do not oil out in the absence of a blowing agent. Denser more solid impregnated plastics can thus be formed. Preferably, the polymeric resins can be impregnated with a relatively high repellent load of up to 30 weight % of the impregnated plastic.

Further, there exists a need for products manufactured from polymeric resins that have been impregnated with an insect repellent that provide an essentially steady state or zero order sustained release of the repellent over long time periods without suffering from oiling out.

### SUMMARY OF THE INVENTION

It is an object of the invention to prepare non-foamed insect repellent concentrates composed of polymeric resins that have been impregnated with insect repellents without using a blowing agent and in which the repellent does not oil out. The concentrates of the present invention are prepared by introducing the polymeric resin into the barrel of either a single screw or twin screw extruder and melting the polymeric resin prior to the introduction of the insect repellent. The resulting mixture of polymeric resin and insect repellent is homogeneously and uniformly mixed before exiting the extruder, effectively “emulsifying” the repellent into a fine dispersion. The dispersion consists of small, less than a micron, domains of insect repellent dispersed uniformly in the resin matrix. Upon exiting the extruder, the mixture can be pelletized using a pelletizer to form non-foamed resin/insect repellent pellet concentrates having high insect repellent concentrations.

It a further aspect of the invention to provide products that incorporate these non-foamed insect repellent concentrates. The finished concentrates may be packaged for shipment or used directly in the manufacture of products where the insect repellent remains homogeneously dispersed during the life of the products. Products that can incorporate the insect repellent/polymer compositions of the present invention include garbage bags, lawn bags, plastic tablecloths and plastic garbage receptacles. The products using the concentrates of the present invention exhibit steady state (zero order) release of the insect repellent components of the concentrate.

### DETAILED DESCRIPTION OF THE INVENTION

The present invention includes non-foamed insect repellent concentrates that comprise polymeric resins that have been impregnated with insect repellents without using a blowing agent. Any effective amount of insect repellent on the order of about 1% of the weight of the resin up to about 30% by weight of the resin may be used. The higher end of the range represents a relatively high insect repellent loading. Preferably the weight percent of the insect repellent in the impregnated resin composition is about 15-25 weight %, and even more preferably about 18-22 weight %. The exact concentration is a function of the polymer resin used and the end use of the impregnated resin. Mixing to obtain a fine dispersion of insect repellent in the polymer resin is done at relatively low temperatures, generally about 10° C. above the melting point of the polymer resin used.

Industry has generally assumed that higher processing temperatures lower resin viscosity and thereby permit better mixing of materials. It has now been found that lower processing temperatures, allowing for higher resin viscosities, are in fact more advantageous for dispersing insect repellents in polymeric resins. With lower temperatures and higher viscosities, the distributive mixing elements at the end of the extruder's screws function more effectively and allow for finer dispersions of the insect repellent. In addition, the pressure at the end of the extruder adjacent to the die is maintained at a level such that the resin and repellent are kept in the distributive mixing region longer allowing for better repellent dispersion and smaller repellent globules.

The fine dispersion of the liquid insect repellent is obtained by intensive distributive mixing in the extruder from which the impregnated plastic is obtained. The mixing results in small sub micron size domains of liquid insect repellent being dispersed uniformly in the resin matrix. The resulting sub micron size domains provide for maximum entrapment of the liquid insect repellent in the resin, thereby eliminating oiling out of the liquid on the pellet surface. This is true despite the relatively high repellent loads used.

An advantage of the present invention is that inter alia it allows for the use of environmentally friendly insect repellents. These insect repellents contain components, a substantial portion of which are natural products, natural product derivatives or synthesized versions of naturally occurring relatively environmentally benign materials.

In producing the polymeric resins impregnated with insect repellents of the subject invention, various polymers may be utilized, such as, for example, low-density polyethylene (LDPE), linear low density polyethylene (LLDPE), very low density polyethylene (VLDPE), high-density polyethylene (HDPE), polyethylene (PE), and polypropylene (PP). Additionally the following resins can also be used: blended polyethylene and carbon black, as disclosed in U.S. Pat. No. 4,369,267; polystyrene, as disclosed in U.S. Pat. No. 4,369,227; polyene/alpha-olefin copolymers, as disclosed in U.S. Pat. No. 4,369,291; poly-alpha-olefins, as disclosed in Canada Patent 1,137,069; polymeric compositions, as disclosed in Canada Patent 1,137,068; poly-alpha-olefins, as disclosed in Canada Patent 1,137,067; polyolefins, as disclosed in Canada Patent 1,137,066; polyethylene oxides, as disclosed in Canada Patent 1,137,065; olefin polymers and co-polymers, as disclosed in Canada Patent 1,139,737; polyolefins, as disclosed in Canada Patent 1,139,738; chlorinated PVC, as disclosed in Polymer 1982, 23 (7, Suppl.), 1051-6 abstracted at Chem. Abstracts 97:145570y, 1982; polyepsilon caprolactone co-polymers made by means of alcohol initiated polymerization, as disclosed in J. Polym. Sci. Polm. Chem. Ed. 1982, 20(2), pages 319-26, abstracted at Chem. Abstracts, Volume 96:123625x, 1982; styrene-acrylonitrile co-polymers, as disclosed in Diss. Abstracts, Int. B, 1982, 42(8), 3346 and abstracted at Chem. Abstracts 96:143750n(1982); co-polymers of epsilon caprolactone with 1,4-butanediol, as disclosed in Kauch. Rezine, 1982, (2), 8-9, abstracted at Chem. Abstracts, Volume 96:182506g (1982); polyesters, as disclosed in U.S. Pat. No. 4,326,010; chlorinated polyethylene, as disclosed by Belorgey, et al. J. Polym. Sci. Polym. Phys. Ed. 1982, 20(2), 191-203; plasticized polyepsilon caprolactone co-polymers containing dimethyl phthalate platicizers, as disclosed in Japan Patent J81/147844; maleic anhydride modified adducts of polyepsilon caprolactone polyols and ethylenically unsaturated monomer, as disclosed in U.S. Pat. No. 4,137,279; polyurethane polymers having lactone backbones, as disclosed in U.S. Pat. No. 4,156,067; polyurethane polyether resins wherein the resin is obtained by reacting a polyfunctional lactone with a long chain polyalkylene diol and a urethane precursor, as disclosed in U.S. Pat. No. 4,355,550; and, resins having polyurethane backbones, as disclosed in U.S. Pat. No. 3,975,350.

Additionally, co-polymers may be used, such as, for example, vinyl chloride or ethylene co-polymerized with a polar vinyl monomer selected from (a) vinyl acetate; (b) ethyl acrylate; (c) methyl acrylate; (d) butyl acrylate; and (e) acrylic acid including the hydrolyzed co-polymer of ethylene and vinyl acetate. Specific co-polymers, among others, that may be used are: ELVAX ethylene-vinyl acetate co-polymers, marketed by E.I. duPont de Nemours Company and ethylene-ethyl acrylate co-polymers, marketed by Dow Corporation.

For applications such as garbage bags, typical polymer resins that can be used are LLDPE having densities of about 0.92-0.94 g/cc and PE having densities of about 0.89-0.96 g/cc. The melt indices of the PE and LLDPE resins used can range from 1-20, preferably from 2-6 and even more preferably from 2-3.

To prepare the non-foamed concentrates of the present invention, a polymeric resin, homo- or copolymer resin, as required, is introduced into the barrel of either a single screw or twin-screw extruder where the polymeric resin is melted prior to the introduction of the insect repellent composition. The insect repellent is added and agitated. The resulting mixture of polymeric resin and insect repellent is homogeneously and uniformly mixed so that the liquid is essentially dispersed into a fine dispersion before exiting the extruder. Typically, when the insect repellent has a weight percent of 15% of the entire composition, the size of the liquid insect repellent globules is of the order of 0.5 microns. By means of the die of the extruder, one can create rods, sheets, films, ribbons or any other geometric shapes for use as repellent concentrates or in finished products. Upon exiting the extruder, the mixture is cooled and typically pelletized using any of a number of pelletizers known in the art. Specific examples of pelletizers which may be used are strand pellitizers, die face under water pellitizers and die face dry cut pellitizers. These finished pellets may then be packaged for shipment or used directly in the manufacture of end products that incorporate the insect repellent impregnated polymeric resin pellet concentrates.

A typical pellet comprising insect repellent 20% by weight, produced using:

1. a PE resin having a density of 0.92 g/cc and a melt index of 2, and

2. an insect repellent composition as in Table I below, has a density of about 0.92 g/cc and a melt index of about 8-12.

The selected polymer resin is loaded into the extruder at a feed rate typically in the range of from about 80 up to about 300 pounds per hour while maintaining the temperature in the extruder between about 110° C. and about 160° C. The temperature is determined by the polymeric resin used and generally is about 10° C. above the melting temperature of the resin. The polymer, or co-polymer, resin is added at a reference barrel segment of the extruder. Downstream from the reference barrel and under pressure, the insect repellent is added to the extruder. The die pressure ranges from about 500 to about 2000 psi, preferably from about 500 to about 1000 psi.

The preferred feed rate of the polymeric resin is dependent on the extruder size (diameter) and rpm rate limit. A typical output rate for a 25% active insect repellent in LDPE (density 0.92 g/cc with a melt index of 2) made using a twin-screw extruder is 100 to 400 lbs per hour.

The polymer resin is added into the extruder by a dosing unit (feeder) while the liquid insect repellent is injected directly into the extruder barrel under pressures of 200-2000 psi. The preferred pressure for injecting the repellent is 200 to 500 psi. The rate of injection is adjusted according to the weight percent of repellent in the finished concentrate. Injection of the repellent is effected at room temperature.

Any industry standard single or twin-screw extruder may be used to form the polymeric resins impregnated with insect repellents of this invention. The extruders may have to be modified to allow for the introduction of the insect repellent composition downstream from the introduction of the polymer resin. Particular types of extruders are listed in Modern Plastics 2001 World Encyclopedia, pages D-105-D-116, published by Chemical Week Publishing LLC (2001). Generally a twin screw extruder is preferable. The twin screw extruder may be either of the co-rotating or counter rotating type, with the latter more preferable. Typical such extruders can be obtained from Krupp, Werner & Pfleider Corp., Ramsay, N.J.

Experiment has demonstrated the long lasting effect and steady-state release of repellent from pellets produced according to the present invention. Where an insect repellent composition as described in Example 1 below is used and where the insect repellent constitutes 25% by weight of a PE pellet, 60% of the pellet's volatile components, i.e. the insect repellent composition, are lost within 21 days. This decrease is essentially linear over the three-week period. The remaining loss of volatile components decreases linearly over time for about a year. After a year, substantially all the repellent has evaporated.

The specific insect repellent composition chosen depends on the end use of the non-foamed insect repellent concentrate. In preferred embodiments of the composition, the insect repellents used include at least one of the following oils: citronella oil, geranium oil, rosemary oil or peppermint oil. In some embodiments, all of these oils could be used together. Preferred insect repellents may further include one or more of the following: D-limonene, aldehyde C-14, aldehyde C-18, eucalyptus oil, lavender oil, and piperitone. Often D-limonene, aldehyde C-14, and aldehyde C-18 are used together. As desired, fragrances and diluents may be added. The above mentioned components of the insect repellents are all readily available from commercial sources such as International Flavors and Fragrances, Hazlet, N.J., Givaudan S A, Vernier Switzerland, and Libenn Aroma Inc, Corona Calif. One particular insect repellent that may be used is formulated as shown in Example 1.

### EXAMPLE 1

Powdered vanillin (1.40 g), heliotropine (0.29 g) and anethole (0.29 g) were added to orange terpenes (46.34 g) in a standard laboratory beaker (500 ml) equipped with a magnetic stirring bar and stirred until the powders were completely dissolved. The remaining components from Table I were than added to the stirring solution to prepare the desired insect repellant composition. The relative percentages of the components in the composition are represented by weight in Table I.

TABLE I

| | Weight Percent of |
|---|---|
| Component | Insect Repellent |
| orange terpens | 46.34%, |
| lavandin oil | 8.58%, |
| d-limonene | 4.54%, |
| grapefruit oil | 4.46%, |
| lemon oil | 4.39%, |
| lavender oil | 4.17%, |
| geranium oil | 4.16%, |
| spearmint oil | 3.47%, |
| citronella oil | 3.25%, |
| lynalool | 2.68%, |
| pine needle oil | 2.24%, |
| spike lavender | 2.19%, |
| oil petitgrain mandarin | 1.50%, |
| vanillin | 1.40%, |
| peppermint oil | 1.16%, |
| citral | 1.13%, |
| iso-bornyl acetate | 0.95%, |
| rosemary oil | 0.76%, |
| aldehyde C-10 | 0.59%, |
| aldehyde C-14 | 0.40%, |
| aldehyde C-18 | 0.39%, |
| eucalyptus oil | 0.31%, |
| anethole | 0.29%, |
| heliotropine | 0.29%, |
| neroli oil | 0.20%, |
| piperitone | 0.10%, |
| N-amyl alcohol | 0.06% |
| | 100.00% |

### EXAMPLE 2

75 pounds of LDPE resin (density 0.90 g/cc, melt index 3) obtained from Exxon Chemical Co., Houston TX, was added to a twin-screw extruder (Werner & Pflieder). The resin was melted and kept at a temperature about 10° C. above its melting point (about 120° C.). Downstream from the point where the resin melted, 25 pounds of the insect repellent composition shown in Table I was injected under pressure into the extruder using a Zenith injection pump obtained from Zenith Pumps, Sanford, N.C. The resin-repellent mixture was mixed within the extruder until a fine dispersion was formed. The dispersion contained insect repellent globules having sizes less than about 1 micron. The liquid resin/ repellent mixture was than passed through a die where the extruded composition was cooled and formed into a cylindrical shape. The die pressure was kept at 750 psi. The extruded material was then transported to a strand pellitizer where the extruded concentrated insect repellent containing resin was pelletized into non-foamed insect repellent pellet concentrates.

### EXAMPLE 3

The same procedure as in Example 4 but the polymer resin used is a polypropylene-polyethylene copolymer having a composition containing 6% polyethylene and a melt flow rate of 30. (Fina PP7825, Fina Oil & Chemical Co., Dallas Tex.). Since the melting point of this copolymer resin is 145° C., the processing temperature is kept at a temperature of about 155° C., again about 10° C. above its melting point.

The finished non-foamed insect repellent impregnated concentrates, usually, but not necessarily, in the form of pellets, then may be used to make a myriad number of products, such as, but not limited to, plastic garbage/lawn bags, plastic garbage receptacles, plastic tablecloths and biodegradable film netting for covering crops. Known techniques in the plastics industry may be used to incorporate the non-foamed insect repellent pellet concentrates into these various end products. For example, fabricating bag-like products would generally employ blown film extrusion, while fabrication garbage receptacles would employ injection molding. The products employing the concentrates of the invention provide for long-term, steady state release of the insect repellent components. A typical procedure for fabricating bag-like products according to the present invention is set forth below.

### EXAMPLE 4

Non-foamed insect repellent pellet concentrates containing 25% by weight of insect repellent in a PE matrix are added to a HDPE resin (density 0.96 g/cc) (Dow). The weight percent of the pellet concentrates added is about 1.5% of the total weight of the mixture. The mixture is melted in the extruder. The extruder barrel is heated to about 165° C., but any temperature in the range from about 150° C. to about 180° C. would also be acceptable. The pellet concentrates are added via an additive feeder downstream from where the HDPE is added. In addition, other additives are introduced through the feeder. These include colorants of about 2 weight %; talc as an anti-blocking agent in the amount of about 1.5 weight %; and erucamide (Uniquema Corp, New Castle Del.) as a slip agent in the amount of about 2 weight %. All the weight percents cited are in relation to the entire mixture introduced into the extruder. After addition, the pellet concentrates and other additives are intensively mixed with the melted HDPE to ensure a fine dispersion of insect repellent. The mixture is then extruded and formed into a tube. The tube is blown into a film as is typical in blown film extrusion. Blown film processing is described in Modem Plastics 2001 World Encyclopedia, pages D-14-D-19, published by Chemical Week Publishing LLC (2001) and on the Dow Polyethylene Internet site. The blown film bubble is cooled, folded, heat sealed and cut to form a bag.

The weight percentage of insect repellent in a finished bag using the non-foamed insect repellent pellet concentrates described above can range from 0.25-5%, preferably 1-4% more preferably 1-2% and even more preferably 1-1.4%, depending on the end use of the product being manufactured.

When using injection molding to make end products, such as garbage receptacles, non-foamed insect repellent pellet concentrates typically having an insect repellent concentration of 25% by weight of the concentrate are added to a base resin such as PE. The repellent pellet concentrates typically form 2-60 weight % of the mixture. The solid resin and pellet concentrates and any other additives required, such as colorants usually added in the 1-5% weight % range, are mixed prior to being added to the injection molding unit. Suitable injection molding units are available from Boy Machines Inc., Exton, Pa., Engel Machinery Inc., York, Pa. and Milacron Inc., Batavia Ohio. In the injection molding unit, the mixture is melted and further mixed to ensure a uniform, homogeneous dispersion of repellent in the molten polymeric mixture. The barrel temperature of the injection molding unit typically ranges from about 130° C. to about 160° C. Injection pressures and speed of processing are chosen so that the finished product has a uniform distribution of resin and insect repellent.

When making products using the above described pellet concentrates, it is preferable that the pellet concentrate be made of a polymer resin similar to the resin of the product being manufactured. While this is preferable, the product resin and the pellet concentrates may be of different resins, as long as the melt indices of the two resins are relatively close. A pellet concentrate having a melt index of 4 would be usable in a product resin having a melt index of 2.

While in the above discussion we have referred to the insect repellent extrudate as being formed into pellet concentrates, it should be clear to those skilled in the art that extrudate repellent concentrates can have other geometric shapes. The die of the extruder may create rods, sheets, films, ribbons, and other shapes depending on the particular die used.

Additionally, above we have described the use of non-foamed insect repellent concentrates as an intermediate product suitable for incorporation into end products. It should be apparent to one skilled in the art that the extrudate of the polymer-insect repellent mixture can itself be used to form end-products.

While the present invention has been particularly described with reference to certain embodiments, it will be apparent to those skilled in the art that many modifications and variations may be and still be within the spirit and scope of the invention. The invention is accordingly not to be construed as limited in any way by the illustrated embodiments; rather its concept is to be understood according to the spirit and scope of the claims which follow.

1. A non-foamed insect repellent concentrate, comprising:
a polymeric resin; and
an insect repellent, wherein said insect repellent is homogeneously and finely dispersed throughout said polymeric resin without a blowing agent and wherein said dispersed insect repellent exists as globules of less than 1 micron in size within said resin which provides a non-foamed matrix for said repellent.

2. The non-foamed insect repellent concentrate according to claim 1, wherein said insect repellent is present in an amount from about 1 to about 30% by weight of the polymeric resin.

3. The non-foamed insect repellent concentrate according to claim 2, wherein said insect repellent is present in an amount from about 15 to about 25% by weight of said polymeric resin.

4. The non-foamed insect repellent concentrate according to claim 3, wherein said insect repellent is present in an amount from about 18 to about 22% by weight of said polymeric resin.

5. The non-foamed insect repellent concentrate according to claim 1, wherein said polymeric resin is a homo-polymer resin.

6. The non-foamed insect repellent concentrate according to claim 5, wherein said polymeric resin is a polyalkylene.

7. The non-foamed insect repellent concentrate according to claim 6, wherein said polymeric resin is selected from the group consisting of low density polyethylene, very low; density polyethylene, linear low density polyethylene and high density polyethylene.

8. The non-foamed insect repellent concentrate according to claim 1, wherein said polymeric resin is a co-polymer resin.

9. The non-foamed insect repellent concentrate according to claim 8, wherein at least one of the monomers of said co-polymer resin is a polyalkylene.

10. The non-foamed insect repellent concentrate according to claim 9, wherein at least one of the monomers is polyvinylchloride.

11. The non-foamed insect repellent concentrate according to claim 1, wherein said insect repellent substantially comprises components which are natural products, natural product derivatives or synthesized versions of natural products or their derivatives.

12. The non-foamed insect repellent concentrate according to claim 1, wherein said insect repellent is comprised of at least one oil selected from the group consisting of citronella oil, geranium oil, rosemary oil, and peppermint oil.

13. The non-foamed insect repellent concentrate according to claim 1, wherein said insect repellent comprises: citronella oil; geranium oil; rosemary oil; and peppermint oil.

14. The non-foamed insect repellent concentrate according to claim 12, wherein said insect repellent further comprises at least one of the following: D-limonene; aldehyde C-14; aldehyde C-18; lavender oil; piperitone; and eucalyptus oil.

15. The non-foamed insect repellent concentrate according to claim 12, wherein said insect repellent further comprises at least one fragrance compound.

16. The non-foamed insect repellent concentrate according to claim 15, wherein said at least one fragrance compound is selected from the group consisting of spearmint oil, iso-bornyl acetate, vanillin, anethole, heliotropine, pine needle oil, aldehyde C-10, lynalool, citral, lemon oil, grapefruit oil, N-amyl alcohol, lavandin oil, spike lavander, oil petitgrain mandarin, orange terpens and neroli oil.

17. A process for preparing a non-foamed insect repellent concentrate, the process comprising the following steps:
introducing a polymeric resin into an extruder;
melting the polymeric resin in the extruder, the temperature of the extruder being maintained at a temperature about 10° C. above the melting temperature of the polymeric resin;
adding an insect repellent under pressure into the extruder at a point downstream from the point where the polymeric resin is introduced into the extruder;
mixing the melted resin and the insect repellent so that a homogenous dispersion is obtained having insect repellent globules dispersed throughout the melted resin; and
extruding the insect repellent containing polymeric resin from the extruder.

18. The process according to claim 17, wherein the polymeric resin is introduced into the extruder at a feed rate of from about 80 up to about 300 pounds per hour.

19. The process according to claim 17, wherein the temperature in the extruder is maintained between about 110° C. and about 160° C.

20. The process according to claim 17, wherein the insect repellent is present in an amount between about 1 to about 30 weight % of the polymeric resin.

21. The process according to claim 20, wherein the insect repellent is present in an amount of between about 15 to about 25 weight % of the polymeric resin.

22. The process according to claim 21, wherein the insect repellent is present in an amount of between about 18 to about 22 weight % of the polymeric resin.

23. The process according to claim 17, further comprising the step of pelletizing the extruded non-foamed insect repellent concentrate.

24. The process according to claim 17, wherein the non-foamed insect repellent concentrate is extruded into a die from the extruder in the extruding step at pressures ranging from about 500 to about 2000 psi.

25. The process according to claim 24, wherein the non-foamed insect repellent concentrate is extruded into a die from the extruder at pressures ranging from about 500 to about 1000 psi.

26. The process according to claim 17 wherein the insect repellent is added into the extruder at a pressure of 200-2000 psi.

27. The process according to claim 26, wherein the insect repellent is added into the extruder at a pressure of 200-500 psi.

28. The process according to claim 17, wherein the insect repellent globules are less than a micron in size.

29. A product exhibiting steady state release of an insect repellent, comprising:
a non-foamed insect repellent concentrate comprising:
a polymeric resin; and
an insect repellent, wherein said insect repellent is homogeneously and finely dispersed throughout said polymeric resin without a blowing agent and wherein said dispersed insect repellent exists as globules of less than 1 micron in size within said resin which provides a non-foamed matrix for said repellent; and
a polymeric resin.

30. A product according to claim 29, wherein said product is prepared by extrusion.

31. A product according to claim 30, wherein said product is selected from the group consisting of plastic tablecloths, plastic garbage bags, plastic lawn bags and plastic film netting.

32. A product according to claim 29, wherein said product is prepared by injection molding.

33. A product according to claim 32, wherein said product is a plastic garbage receptacle.

34. A product exhibiting steady state release of an insect repellent, comprising:
a non-foamed insect repellent concentrate comprising:
a polymeric resin; and
an insect repellent, wherein said insect repellent is homogeneously and finely dispersed throughout said polymeric resin without a blowing agent and wherein said dispersed insect repellent exists as globules of less than 1 micron in size within said resin which provides a non-foamed matrix for said repellent.

35. A product exhibiting steady state release of an insect repellent, comprising:
a polymeric resin; and
a non-foamed insect repellent concentrate prepared according to the process of claim 17 or claim 23, wherein the insect repellent of said concentrate is homogeneously and finely distributed throughout the product.
